(19) United States
(12) Patent Application Publication
(10) Pub. No.: US 2008/0217943 A1
(43) Pub. Date: Sep. 11, 2008

(54) Skin materials joined portion fixing construction for skin covered article

(75) Inventors: Hiroshi Iwata, Aichi-ken (JP); Masanobu Muto, Aichi-ken (JP); Takahiko Sato, Aichi-ken (JP); Atsushi Hiroshige, Okazaki-shi (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD., Nishikasugai-gun (JP)

(21) Appl. No.: 12/073,559

(22) Filed: Mar. 6, 2008

(30) Foreign Application Priority Data
Mar. 7, 2007 (JP) 2007-057275

(51) Int. Cl. B60N 3/00; B60R 27/00; B68G 13/00

(52) U.S. Cl. 296/24.34; 29/91

(57) ABSTRACT

A center console 20 is formed by covering a console main body 35 by a skin main body 31 having a joined portion 37 where end portions of an upper surface skin material 31a and a side surface skin material 31b are joined together. On the skin main body 31, core members 38, 39 are provided along the joined portion 37, and a recessed portion 35a formed in an edge portion of the console main body 35 and a raised portion 37a formed by the core members 38, 39 on the side of the skin main body 31 are fitted on or in together.

### BACKGROUND OF THE INVENTION

1. Field of the Invention

The present invention relates to a joined portion fixing construction for a skin covered article which is formed by forming a base material with a skin main body having a skin materials joined portion where end portions of skin materials are joined together for fixing the skin materials joined portion to a desired position on a base material.

2. Description of the Related Art

Conventionally, skin covered articles which are formed by covering base materials of resin or the like with skin materials are used for interior parts installed in, for example, a motor vehicle. In these skin covered articles, there are, for example, a skin covered article, as is described in Patent Document Nos. 1 and 2, which is formed by injecting a foaming resin into a skin bag formed in advance by a skin material and a skin covered article, as is described in Patent Document No. 3, which is formed by placing a skin material over a base material to cover the material. In addition, in these skin covered articles, there have been made studies on the enhancement of external appearance and function of the part where the end portions of the two skin materials join or overlap.

In the skin covered article described in Patent Document No. 1, a slit from which urethane resin is injected is formed by bringing the end portions of the skin material which forms the skin bag into abutment with each other, and the end portions of the skin material are both folded back to the inside of the skin bag to become double in layer.

In addition, in the skin covered article described in Patent Document No. 2, an elastic plate is sewn to an opening of the skin bag from which resin is injected thereinto, so that the forming resin injecting opening is made to be closed by this elastic plate.

In the skin covered article described in Patent Document No. 3, in joining the two skin materials, one skin material is sewn to the other skin material in such a state that a core material is wrapped in the end portion thereof. Specifically, this core material is formed into an axial shape which includes a ball portion and a strap portion, and the two skin materials are sewn together in a position which coincides with the strap portion in such a state that the ball portion is wrapped in the one skin material in such a manner as to be disposed at the edge of the one skin material. In addition, since the edge of the one skin material is attached to the surface of the other skin material in such a manner as to form a difference in level relative to the surface of the other skin material due to the ball portion in the portion where the two skin materials are sewn together, a luxury feeling such as an accent or touch of quality given by the edging line is made to be brought about.

Patent Document No. 1: JP-UM-A6-79509

Patent Document No. 2: JP-A-11-313727

Patent Document No. 3: JP-UM-A-568400

Incidentally, in the skin covered article described in Patent Document No. 3 which is formed by placing the skin material over the base material to cover the material, by disposing the skin materials joined portion in the desired part, the joined portion can be made us of for decoration. In the conventional skin covered article like this, however, the positioning of the joined portion is made to largely depend on the skill of people who perform the attachment of the covering material to the base material, and hence, there is caused a fear that the joined portion comes out of alignment with the desired part on the base material or that the shape of the joined portion becomes unstable. In particular, when disposing the skin materials joined portion in a three-dimensionally curved part of the base material, there is caused a large fear that the joined portion comes out of alignment with the desired part, leading to a fear that an aesthetic external appearance desired for the skin covered article cannot be obtained.

### SUMMARY OF THE INVENTION

The invention has been made in view of these situations and an object thereof is to provide a skin materials joined portion fixing construction for a skin covered article which is formed by covering a base material with a skin main body having a skin materials joined portion where end portions of skin materials are joined together which can fix properly the joined portion to a desired position on the base material.

With a view to attaining the object, the gist of a first aspect of the invention resides in a skin materials joined portion fixing construction for a skin covered article formed by covering a base material with a skin main body having a skin materials joined portion where end portions of skin materials are joined together, including a core member provided along the joined portion of the skin materials, a recessed portion formed by one of the base material and the core member, and a raised portion formed by the other of the base material and the core member in such a manner as to fit in the recessed portion.

In the configuration described above, the recessed portion and the raised portion include not only those which are formed only by the base material or the core member but also those in which part of the recessed portion or the raised portion is formed by the other material such as the skin material. In addition, by the core member being provided along the joined portion of the skin materials and the raised portion formed on the skin main body side by the core member and the recessed portion formed in the predetermined position on the base material being fitted in or on each other, or the recessed portion formed on the skin main body side by the core member and the raised portion formed in the predetermined position on the base material being fitted in or on each other, the base material is fixed to the predetermined position on the base material, whereby the skin materials joined portion can stably be fixed to the predetermined position on the base material without being caused to get misaligned with the predetermined position on the base material. In addition, when the skin covered material is used over a long period of time, since the recessed portion formed by one of the base material and the core member and the raised portion formed by the other is fitted in or on, the skin materials joined portion is restrained from coming out of alignment with the desired position on the base material, which would otherwise be caused due to aging.

The gist of a second aspect of the invention resides in a skin materials joined portion fixing construction for a skin covered article as set forth in the first aspect of the invention, wherein the core member is made of a flexible material.

According to the configuration described above, since the core member is flexible, even though the predetermined position on the base material is of, for example, a three-dimensionally curved shape, the core member can be curved flexibly to follow the configuration of the predetermined position, thereby making it possible to ensure that the core member is fixed to the predetermined position on the base material. Namely, by using a flexible material as the core member, irrespective of the configuration of the predetermined position on the base material, the skin materials joined portion can be fixed to the predetermined position.

Note that for example, rubber, hard sponge and the like are raised as examples of flexible materials that can make up the core member.

The gist of a third aspect of the invention resides in a skin materials joined portion fixing construction for a skin covered article as set forth in the first or second aspect of the invention, wherein the core member is provided at the end portion of each of the skin materials.

According to the configuration described above, since the core member is provided on each of the skin materials, the joined portion where the skin materials are joined together can be fixed more strongly to the predetermined position on the base material, thereby making it possible to ensure that the joined portion is restrained from coming out of alignment with the predetermined position.

The gist of a fourth aspect of the invention resides in a skin materials joined portion fixing construction for a skin covered article as set forth in any of the first to third aspects of the invention, wherein the end portions of the skin materials are each folded double in such a manner that a distalmost end of the end portion is situated inside the skin material.

According to the configuration described above, since the distalmost end of the end portion of the skin material is not exposed, the aesthetic external appearance of the skin materials joined portion of the skin covered article is increased, whereby the decorative function of the joined portion can be exhibited effectively.

The gist of a fifth aspect of the invention resides in a skin materials joined portion fixing construction for a skin covered article as set forth in the fourth aspect of the invention, wherein the core member is covered by the double folded part of the end portion of the skin material.

According to the configuration described above, the double folded part of the skin material covers the core member, whereby the shape of the double folded part is formed stably, so that the decorative function of the joined portion is exhibited more.

The gist of a sixth aspect of the invention resides in a skin materials joined portion fixing construction for a skin covered article as set forth in the fourth or fifth aspect of the invention, wherein the recessed portion is formed in the base material, while the raised portion is formed at a distalmost end of the raised portion and the core member.

According to the configuration described above, since the distalmost end of the skin material is accommodated in the recessed portion on the base member, the distalmost end of the skin material is restrained from being peeled away from the base material.

According to the invention, the skin materials joined portion can stably be fixed to the predetermined position on the base material without being caused to come out of alignment therewith.

### BRIEF DESCRIPTION OF THE DRAWINGS

FIG. 1 is a perspective view showing a center console to which a skin materials joined portion fixing construction according to an embodiment of the invention and an instrument panel.

FIG. 2 is a perspective view showing a console main body and a skin main body of the center console.

FIG. 3 is a partial sectional view taken along the line A-A in FIG. 2.

FIG. 4 is a partial sectional view showing a skin materials joined portion fixing construction according to a first modified example.

FIG. 5 is a partial sectional view showing a skin materials joined portion fixing construction according to a second modified example.

FIG. 6 is a partial sectional view showing a skin materials joined portion fixing construction according to a third modified example.

FIG. 7 is a partial sectional view showing a skin materials joined portion fixing construction according to a fourth modified example.

FIG. 8 is a partial sectional view showing a skin materials joined portion fixing construction according to a fifth modified example.

FIG. 9 is a partial sectional view showing a skin materials joined portion fixing construction according to a sixth modified example.

FIG. 10 is a partial sectional view showing a skin materials joined portion fixing construction according to a seventh modified example.

FIG. 11 is a partial sectional view showing a skin materials joined portion fixing construction according to an eighth modified example.

FIG. 12 is a partial sectional view showing a skin materials joined portion fixing construction according to a ninth modified example.

### DESCRIPTION OF THE PREFERRED EMBODIMENTS

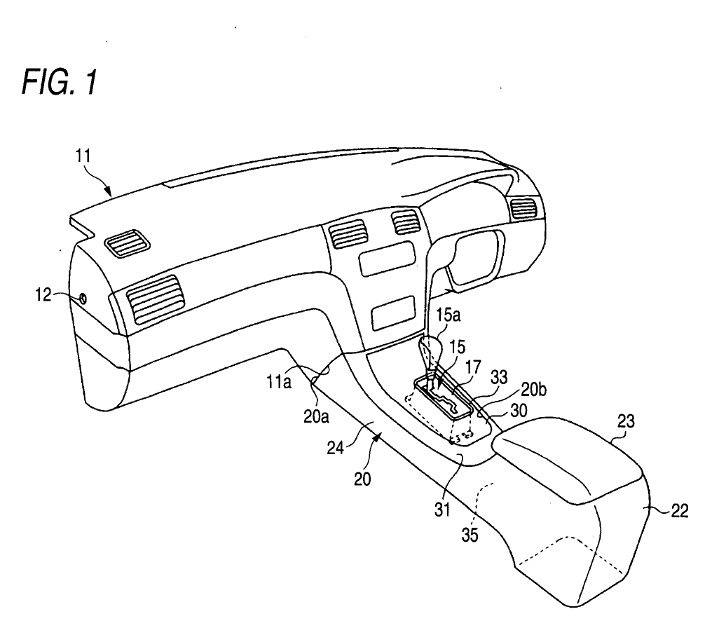

Hereinafter, an embodiment will be described based on FIGS. 1 to 3 which embodies a skin materials joined portion fixing construction of the invention. A skin covered article of this embodiment is a center console equipped on a vehicle.

As is shown in FIG. 1, an instrument panel 11 is disposed at the front of an interior of a passenger compartment of the vehicle in such a manner as to extend in a vehicle width or transverse direction. This instrument panel 11 is so mounted by screwing bolts from through holes 12 in both side portions thereof into a member, not shown, which makes up a body of the vehicle. A center console 20 is mounted in a central position on a floor of the vehicle with a plurality of bolts, not shown. This center console 20 is continuously connected to the instrument panel 11 in such a state that a front edge 20a thereof is brought into abutment with a central lower edge 11a of the instrument panel 11.

As is shown in FIG. 1, the center console 20 includes a console main body 35 which makes up an outer frame of the center console 20, a gearshift lever unit 15 and a lid element 23.

The console main body 35 is formed into a shape which is elongated in a longitudinal direction and includes a table-like portion 24 which is formed into a flat table-like shape in a substantially front half part and a storage console box 22 which is formed in a substantially rear half part in such a manner as to continue to the table-like portion 24. In addition, the console main body 31 is such as to be formed into an integral piece of hard resin and a surface thereof is covered with a skin main body 31 made of genuine leather. Namely, in this embodiment, the console main body 35 constitutes a base material.

An upper opening 20b is provided in an upper surface of the table-like portion 24 of the console main body 35, and a console upper plate 30 is provided at the opening 20b. A plate opening 33 is formed in the console upper plate 30, and the gearshift lever unit 15 is accommodated in the console main body 35 in such a state that the gearshift lever unit 15 is exposed from the plate opening 33. This gearshift lever unit 15 includes a case 17 and a gearshift lever 15a which is provided in such a manner as to project upwards through an interior of the case 17. Note that although the illustration thereof is omitted, for example, a wood grain-like decorative panel is affixed to upper surfaces of the console upper plate 30 and the case of the gearshift lever unit 15. In addition, although the illustration thereof is omitted, an upper portion of the console box 22 of the console main body 35 is opened, and the lid element 23 is disposed on the console box 22 in such a manner as to freely open and close the opening.

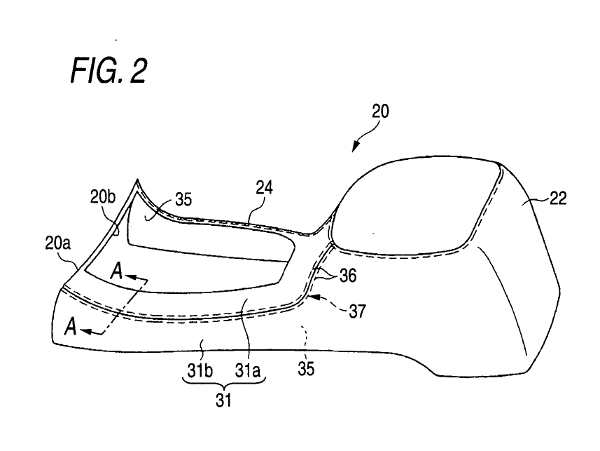

FIG. 2 is a perspective view showing the console main body 35 which is covered with the skin main body 31. To describe the configuration of the front table-like portion 24 of the console main body 35′ in greater detail based on FIG. 2, edge portions where an upper surface intersects side surfaces are curved in such a manner that the width of the table-like portion 24 is gradually reduced as it extends from a front side to a rear side and is also curved in such a manner that the height thereof is gradually reduced in the vicinity of the front edge 20a where the console main body 35 is brought into abutment with the instrument panel as it extends from the front side to the rear side. Namely, the edge portions where the upper surface intersects the side surfaces are curved three-dimensionally at the table-like portion 24 of the console main body 35.

In addition, more specifically, the skin main body 31 which covers the console main body 35 includes an upper surface skin material. 31a which covers the upper surface of the table-like portion 24 which lies in the front half part of the console main body 35 and a side surface skin material 31b which covers all side surfaces of the console main body 35 entirely. In addition, the skin main body 31 includes joined portions 37 where the upper surface skin material 31a and the side surface skin material 31b are joined together by sewing end portions of the upper surface skin material 31 and the side surface skin material 31b together with a sewing yarn 36. Specifically, the joined portion 37 is made into a form in which stitches of the sewing yarn 36 can be recognized from the outside and is disposed along the edge portion of the console main body 35 which is curved three-dimensionally, whereby a desired edging line of the center console 20 is made to be formed.

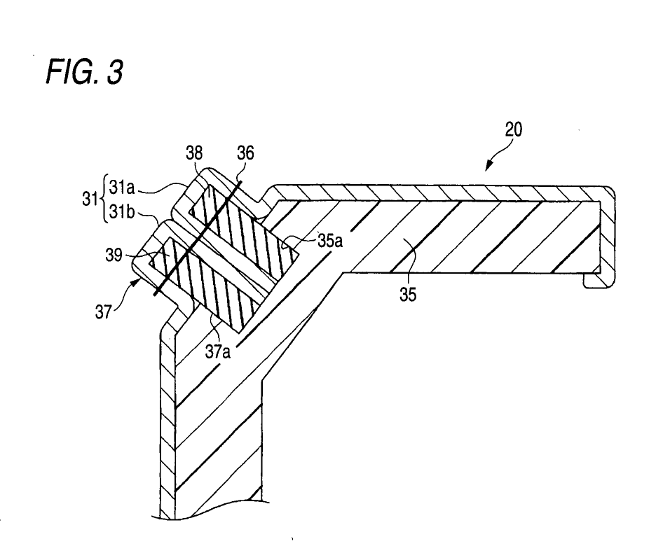

FIG. 3 is a diagram showing a partial sectional construction taken along the line A-A in FIG. 2. As is shown in FIG. 3, more specifically, the edge portion of the console main body 35 is made up of a sloping surface so that the upper surface and the side surface can be connected to each other in a smooth fashion, and a recessed portion 35a is formed in this sloping surface.

In addition, end portions of the skin materials 31a, 31b which forms the joined portion 37 of the skin main body 37 are folded double in such a manner that distalmost ends thereof lie inside of the skin materials 31a, 31b, respectively, and core members 38, 39 are disposed in the double folded distalmost ends, respectively. Specifically, the core members 38, 39 are such that a flexible material such as rubber or hard sponge is formed into a thin long plate-like shape which extends to follow the joined portion 37 and are covered by the double folded parts of the skin materials 31a, 31b on one side thereof, respectively. Then, the sewing yarn 36 is caused to pass through the end portions of the skin materials 31a, 31b and the core members 38, 39 in that state, whereby the joined portion 37 between the skin materials 31a, 31b is formed. In addition; the distalmost ends of the end portions of the skin materials 31a, 31b and end portions of the core members 38, 39 which are not covered with the skin materials 31a, 31b constitute a raised portion 37a in such a manner that the raised portion 37a projects further into the console main body 35 than any other portions of the skin main body 31 which lie in the vicinity of the joined portion 37. In addition, this raised portion 37a is made to be fitted in the recessed portion 35a formed on the sloping surface of the console main body 35.

The following advantages can be obtained according to the embodiment that has been described in detail.

(1) In the center console 20 of the embodiment, in disposing the joined portion 37 of the skin materials 31a, 31b at the edge portion of the console main body 35, the raised portion 37a which is formed by providing the core members 38, 39 in the joined portion 37 of the skin materials 31a, 31b is made to be fitted in the recessed portion 35a provided in the edge portion of the console main body 35, whereby since the joined portion 37 of the skin materials 31a, 31b can stably be fixed to the edge portion of the console main body 35 without being caused to come out of alignment with the edge portion, the joined portion 37 can be made use of as a decoration forming a desired edging line on the console main body 35, thereby making it possible to obtain an aesthetic external appearance desired for the center console 20. In addition, in using this center console 20 for a long period of time, since the raised portion 37a formed by the core members 38, 39 on the skin main body 31 side and the recessed portion 35a formed in the console main body 35 are fitted in or on each other, the possibility can be suppressed that the joined portion 37 between the skin materials 31a, 31b comes out of alignment with the edge portion of the console main body 35 due to aging, thereby making it possible to maintain the desired aesthetic external appearance over such a long period of time.

(2) In the center console 20 of the embodiment, the core members 38, 39 are made to be made of the flexible material such as rubber or hard sponge. Consequently, in this embodiment, although the edge portion of the console main body 35 is formed into the three-dimensionally curved shape, since the core members 38, 39 can be flexibly curved to follow the shape of the edge portion, the raised portion 37a formed by the core members 38, 39 on the skin main body side 31 can be made to be fitted in the recessed portion 35a in the console main body 35 in an ensured fashion. Namely, irrespective of the shape of the edge portion of the console main body 35, it can be ensured that the joined portion 37 between the skin materials 31a, 31b is fixed to the edge portion. Furthermore, since the core members 38, 39 are provided in the double folded parts of the end portions of the skin materials 31a, 31b at the joined portion 37, the parts which are double folded to project are oriented vertical to the sloping surface of the console main body 35, so that the stable shape is maintained. In addition, since the core members 38, 39 are flexible, a soft hand feeling can be given to the user when he or she touches the edge portion, whereby the user is allowed to feel satisfied increasingly in using the center console 20.

(3) In the center console 20 of the embodiment, the core members 38, 39 are provided at the end portions of the skin materials 31a, 31b, respectively, whereby the joined portion 37 where the skin materials 31a, 31b are joined together can be fixed to the edge portion of the console main body 35 more strongly, and hence, the joined portion 37 can be restrained from getting out of alignment with the edge portion.

(4) In the center console 20 of the embodiment, the end portions of the skin materials 31a, 31b are double folded in such a manner that the distalmost ends thereof lie inside the skin materials 31a, 31b, whereby since the distalmost ends of the skin materials 38, 39 are not disposed, the aesthetic external appearance of the joined portion 37 is increased further, and the decorative function of the joined portion 37 is exhibited more effectively.

(5) In the center console 20 of the embodiment, the core members 38, 39 are covered by the double folded parts of the end portions of the skin materials 31a, 31b, respectively, whereby the shape of the double folded parts is maintained stably, and the decorative function of the joined portion 37 is exhibited more effectively.

(6) In the center console 20 of the embodiment, the distalmost ends of the skin materials 31a, 31b are made to constitute the raised portion 37a on the side of the skin main body 31 together with the end portions of the core members 38, 39. Namely, in the embodiment, the skin materials 31a, 31b themselves are made to fit in the recessed portion 35a on the console main body 35, whereby the joined portion 37 of the skin main body 31 can be fixed to the edge portion of the console main body 35 more strongly and rigidly.

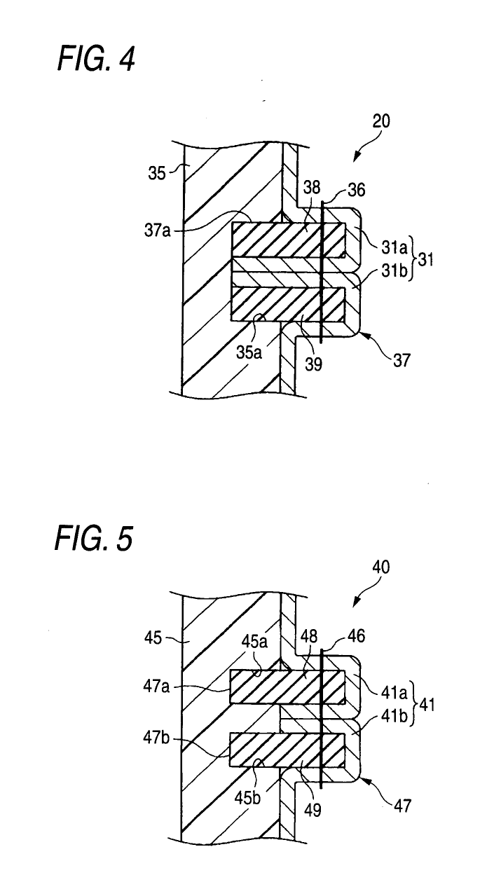

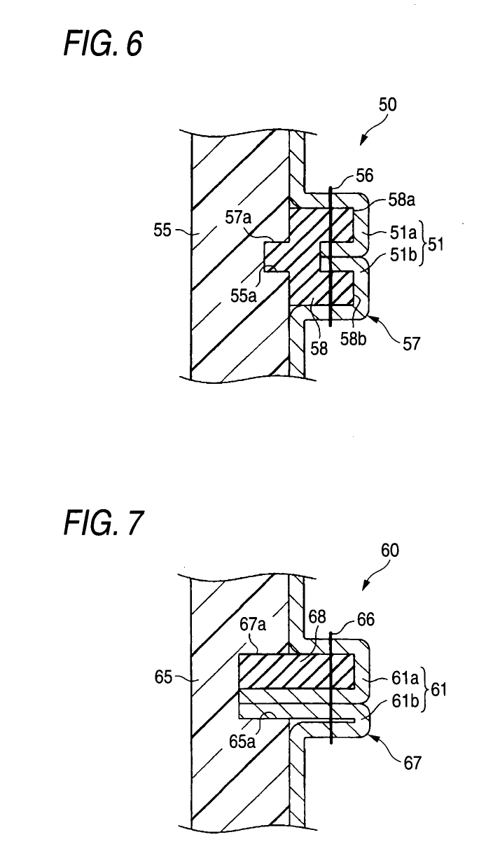

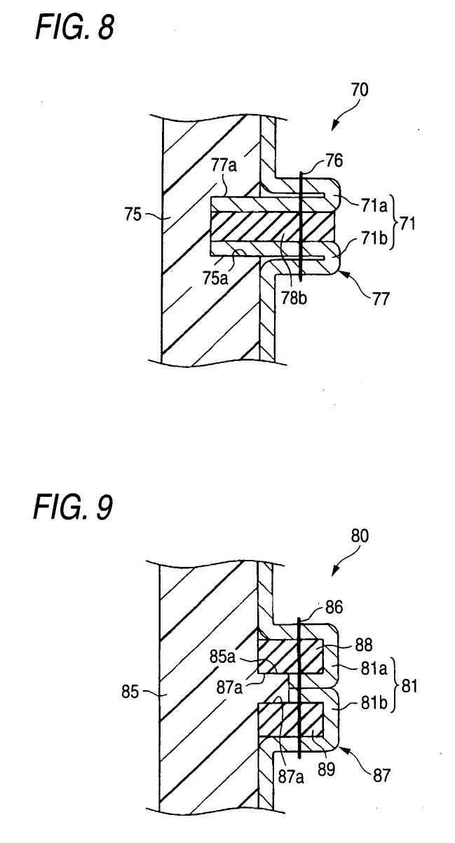

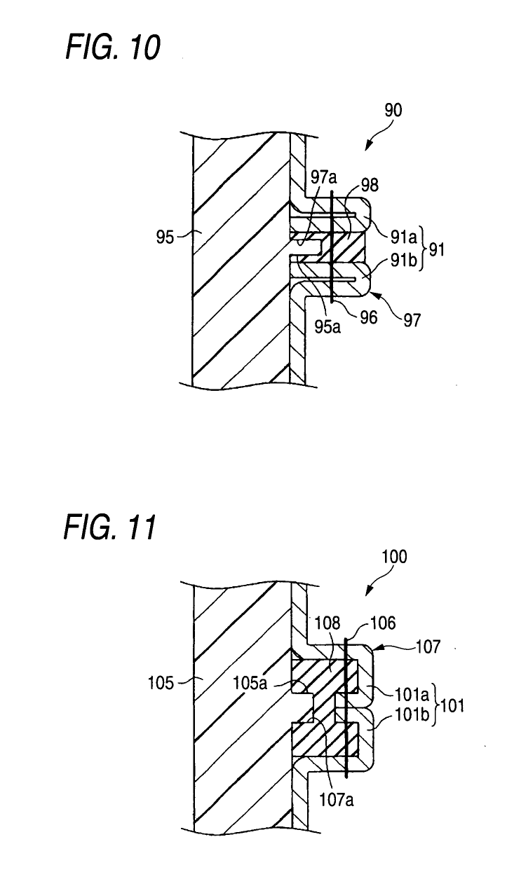

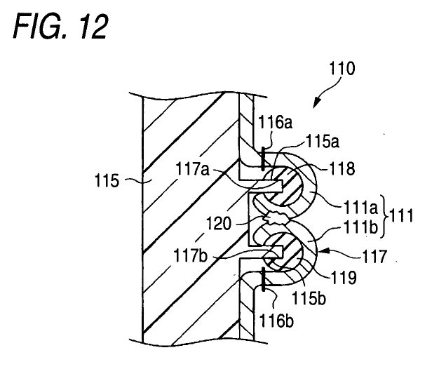

The invention can be embodied into the following modified examples.
FIG. 4 is a partial sectional view showing a center console 20 to which a skin materials joined portion fixing construction of a first modified example is applied. In this modified example, in place of the configuration of the embodiment in which the joined portion 37 of the skin materials 31a, 31b is made to be fixed to the edge portion where the upper surface and the side surface of the console main body 35 intersect each other, a joined portion 37 of skin materials 31a, 31b is made to be fixed to a flat portion of a console main body 35. The flat portion of the console main body 35 is not an edge portion where an upper surface and a side surface of the console main body 35 intersect each other but a flat predetermined position on the side surface or the upper surface thereof. Also, even in such a case, the aforesaid advantage can be obtained. In addition, in the event that the joined portion 37 of the skin materials 31a, 31b is fixed to a predetermined position, which is flat and straight-line, on the console main body 35, since the joined portion 37 may also only have to be fixed in a straight line, core members may be made of a hard material which has no flexibility.
FIG. 5 is a partial sectional view showing a center console 20 to which a skin materials joined portion fixing construction of a second modified example is applied. This modified example is such that two recessed portions 45a, 45b are formed in a console main body 45 in a predetermined position where a joined portion 47 of two skin materials 41a, 41b is fixed, and two raised portions 47a, 47b are formed on the side of a skin main body 41. Specifically, end portions of the two skin materials 41a, 41b are folded double in such a manner as to cover sides of core members 48, 49, respectively, and the other sides of the core members 48, 49 constitute the raised portions 47a, 47b, respectively, which project from the side of the skin main body 41. In addition, distalmost ends of the skin materials 41a, 41b are held between the raised portions 47a, 47b and are disposed so as to face a surface of the console main body 45 which lies between the recessed portions 45a, 45b without being fitted in the recessed portions 45a, 45b. The skin materials 41a, 41b and the core members 48, 49 are joined together in this state with a sewing yarn 46. In addition, the two raised portions 47a, 47b which are formed by the end portions of the core members 48, 49 are fitted in the two recessed portions 45a, 45b of the console main body 45, respectively. In this modified example, since the recessed portions and the raised portions are each provided two; the skin main body 41 can be fixed to the console main body 45 more strongly and rigidly.
FIG. 6 is a partial sectional view showing a center console 50 to which a skin materials joined portion fixing construction of a third modified example is applied. In this modified example, in place of the configuration of the embodiment in which the core members are provided two in each of the joined portions, in a skin main body 51, a core member 58 is made to be provided only one for a joined portion 57. Specifically, in this core member 58, a first raised portion 58a and a second raised portion 58b are provided on one side of the core member 58 in such a manner as to be covered by double folded parts of end portions of two skin materials 51a, 51b, respectively, and distalmost ends of the skin materials 51a, 51b are fitted in a relatively recessed part which lies between the first raised portion 58a and the second raised portion 58b. In addition, this core member 58 and the two skin materials 51a, 51b are sewn to be joined together with a sewing yarn 56. On the other hand, a third raised portion 57a is provided on the other side of the core member 58 in such a manner as to project towards the side of a console main body 55. In addition, a recessed portion 55a, into which the third raised portion 57a is adapted to be fitted, is provided in a predetermined position on the console main body 55. In this modified example, since the one core member 58 is fitted in the recessed portion 55a on the console main body 55, the step of fitting the third raised portion 57a and the recessed portion 55a in or on together can be performed very easily.
FIG. 7 is a partial sectional view showing a center console 60 to which a skin materials joined portion fixing construction of a fourth modified example is applied. In this modified example, in place of the configurations of the embodiment and modified examples in which the two skin materials cover the core members or the core member, a skin main body 61 is made such that while a skin material 61a is double folded at one end portion in such a manner as to cover one side of a core member 68, the other skin material 61b is simply double folded at one end portion without covering any core member. Then, the end portions of the skin materials 61a, 61b are sewn together with a sewing yarn 66 to form a joined portion 67 in such a state that only one of the end portions covers the core member 68. In addition, the other side of the core member 68 forms a raised portion 67a together with distalmost ends of the two skin materials 61a, 61b, and this raised portion 67a is fitted in a recessed portion 65a formed on the side of a console main body 65. In this way, in this modified example, since the core member 68 is provided in only the double folded portion of the skin material 61a of the two skin materials 61a, 61b, the widths of the double folded portions of the skin materials 61a, 61b differ from each other. Consequently, this modified example is effective when adopting a design in which the widths of the double folded portions of the skin materials 61a, 61b are made asymmetrical at a joined portion 67 where the skin materials 61a, 61b are joined together.
FIG. 8 is a partial sectional view showing a center console 70 to which a skin materials joined portion fixing construction of a fifth modified example is applied. In this modified example, in place of the configurations of the embodiment and modified examples in which the core member is provided in the joined portion in such a manner as to be covered by the skin material at the one end thereof, one end of a core member is exposed without being covered with a skin material. Specifically, in a skin main body 71, two skin materials 71a, 71b are folded double in such a manner that distalmost ends thereof lie inside, and a core member 78 is disposed between the skin materials 71a, 71b. The skin materials 71a, 71b and the core member 78 are sewn together with a sewing yarn 76 to form a joined portion 77. In addition, a raised portion 77a is formed on the side of the skin main body 71 by the distalmost ends of the skin materials 71a, 71b and the other side of the core member 78, and this raised portion 77a is fitted in a recessed portion 75a formed in a console main body 75. In this modified example, since the core member 78 is exposed at the joined portion 77 of the skin materials 71a, 71b the core member 78 can be made use of as a decoration by coloring the core member 78 to a desired color.
FIG. 9 is a partial sectional view showing a center console 80 to which a skin materials joined portion fixing construction of a sixth modified example is applied. In place of the configurations of the embodiment and the modified examples in which the recessed portion is formed in the console main body, while the raised portion is formed on the skin main body side, this modified example is made such that a raised portion 85a is formed on the side of a console main body 85, while a recessed portion 87a is formed on the side of a skin main body 81. Specifically, in the skin main body 81, end portions of two skin materials 81a, 81b are folded double to cover end portions of core members 88, 89, respectively. In addition, distalmost ends of the skin materials 81a, 81b are disposed in such a manner as to be held between the two core members 88, 89 in such a state that the distalmost ends are kept situated relatively less inwards than the other sides of the core members 88, 89. Then, the skin materials 81a, 81b and the core members 88, 89 are sewn together by a sewing yarn 86 in this state so as to form a joined portion 87, as well as a recessed portion 87a which is situated between the other sides of the two core members 88, 89. In addition, this recessed portion 87a is fitted on a raised portion 85a which is formed in a predetermined position on the console main body 85. In this way, even in the case where the raised portion 85a is formed on the side of the console main body 85, while the recessed portion 87a is formed on the side of the skin main body 81, as with the embodiment and the modified examples that have been described heretofore, it can be ensured that the joined portion 87 where the skin materials 81a, 81b are joined together is fixed to a desired predetermined position on the console main body 85.
FIG. 10 is a partial sectional view showing a center console 90 to which a skin materials joined portion fixing construction of a seventh modified example is applied. As with the sixth modified example, this modified example is such that a raised portion 95a is provided on the side of a console main body 95, while a recessed portion 97a is formed on the side of a skin main body 91, but in this modified example, only one core member 98 is provided. Specifically, in the skin main body 91, distal ends of two skin materials 91a, 91b are folded double in such a manner that the distalmost ends lie inside, and the core member 98 is disposed in such a manner as to be exposed between the skin materials 91a, 91b on one side thereof. The skin materials 91a, 91b and the core member 98 are sewn together in this state with a sewing yarn 96 so as to form a joined portion 97. In addition, a raised portion 95a is formed in a predetermined position on the console main body 95, and a recessed portion 97a is formed on the core member 98 in such a way that the raised portion 95a fits therein. In this configuration, as well, it can be ensured that the joined portion 97 where the skin materials 91a, 91b are joined together is fixed to a desired predetermined position on the console main body 95.
FIG. 11 is a partial sectional view showing a center console 100 to which a skin materials joined portion fixing construction of an eighth modified example is applied. This modified example is such that the two core members of the sixth modified example shown in FIG. 9 are connected together at central portions thereof so as to be formed into a single core member 108 having an H-shaped cross section. In a skin main body 101, end portions of two skin materials 101a, 101b are folded double so as to cover two raised portions on one side of the core member 108 which is formed to have the H-shaped cross section, and distalmost ends of the skin materials 101a, 101b are fitted in a relatively recessed part between the tow raised portions of the core member 108. Then, the skin materials 101a, 101b and the core member 108 are sewn together with a sewing yarn 106 in this state to thereby form a joined portion 107. In addition, a recessed portion 107a is formed on the other side of the core member 108 having the H-shaped cross section, and a raised portion 105a formed in a predetermined position on the console main body 105 is fitted in the recessed portion 107a.
FIG. 12 is a partial sectional view showing a center console 110 to which a skin materials joined portion fixing construction of a twelfth modified example is applied. In this modified example, in a skin main body 111, core members 118, 119 which are formed into a substantially cylindrical shape are covered by end portions of skin materials 111a, 111b, and the skin materials 111a, 111b are not sewn together but bonded together with an adhesive 120 or the like so as to form a joined portion 117. In addition, recessed portions 117a, 117b are formed, respectively, in the substantially cylindrical core embers 118, 119 on sides thereof which face a console main body 115, and raised portions 115a, 115b are formed on the console main body 115 in such a manner as to fit therein. In addition, stitches by sewing yarns 116a, 116b are applied to the vicinity of the joined portion 117 as decorations which makes the joined portion 117 look like being sewn by those sewing yarns. By utilizing the substantially cylindrically formed core members 118, 119 in this way, end portions of the skin materials 111a, 111b which are joined together are formed into a round shape, whereby the decorative function of the joined portion 117 is exhibited effectively. Note that the end portions of the skin materials may be joined together by other sewing or joining methods than bonding using the adhesive and the stitching using the sewing yarns as decorations may be omitted.
While in the embodiment and the modified examples, the raised portion or the recessed portion is formed on the skin main body side and the recessed portion or the raised portion which corresponds to the raised portion or the recessed portion on the skin main body side is formed on the console main body, for example, a first raised portion and a second recessed portion may be formed on the skin main body side and a first recessed portion which corresponds to the first raised portion and a second raised portion which corresponds to the first recessed portion may be formed on the console main body side. Namely, both the raised portion and the recessed portion may be formed on each of the skin main body side and console main body. In addition, there is no specific limitation on the number of raised portions and recessed portions to be formed in that way.
While in the embodiment and the modified examples, the end portions of the skin materials are folded double in such a manner that the distalmost ends thereof lie inside, the skin materials may be joined together in such a manner that the distalmost ends are exposed.
While in the embodiment and the modified examples, genuine leather is used as the skin material, synthetic leather or cloth material may be used for the skin main body.
While in the embodiment and the modified examples, the skin materials joined portion fixing construction is applied to the center console which is a skin covered article, as a skin covered article like this, automotive interior parts such as glove box, instrument panel and door trim and furniture such as sofa are illustrated, and the skin materials joined portion fixing constructions that have been described heretofore may be applied to those skin covered articles.

What is claimed is:

1. A skin materials joined portion fixing construction for a skin covered article formed by covering a base material with a skin main body having a skin materials joined portion where end portions of skin materials are joined together, comprising:
a core member provided along the joined portion of the skin materials;
a recessed portion formed by one of the base material and the core member; and
a raised portion formed by the other of the base material and the core member so as to fit in the recessed portion.

2. The skin materials joined portion fixing construction for a skin covered article as set forth in claim 1, wherein the core member is made of a flexible material.

3. The skin materials joined portion fixing construction for a skin covered article as set forth in claim 1, wherein the core member is provided at the end portion of each of the skin materials.

4. The skin materials joined portion fixing construction for a skin covered article as set forth in claim 1, wherein the end portions of the skin materials are each folded double in such a manner that a distalmost end of the end portion is situated inside the skin material.

5. The skin materials joined portion fixing construction for a skin covered article as set forth in claim 4, wherein the core member is covered by the double folded part of the end portion of the skin material.

6. The skin materials joined portion fixing construction for a skin covered article as set forth in claim 4, wherein the recessed portion is formed in the base material, while the raised portion is formed at a distalmost end of the raised portion and the core member.
